(19) United States
(12) Patent Application Publication
(10) Pub. No.: US 2005/0209775 A1
(43) Pub. Date: Sep. 22, 2005

(54) Method for determining altitude or road grade information in a motor vehicle

(75) Inventor: Volker Entenmann, Affalterbach (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/085,669

(22) Filed: Mar. 21, 2005

(30) Foreign Application Priority Data
Mar. 22, 2004 (DE) DE 102004014319.6
Jun. 1, 2004 (DE) DE 102004026639.5

(51) Int. Cl. G01C 21/26

(52) U.S. Cl. 701/208; 701/213

(57) ABSTRACT

A method for determining altitude or road grade information in a motor vehicle includes evaluating altitude or road grade information stored in a digital map by analyzing a GPS signal and/or vehicle data-based estimated altitude or road grade information. When indicated based on the evaluation, the altitude or road grade information is corrected and used as the current altitude or road grade information.

Priority is claimed to German patent applications DE 102004014319.6, filed Mar. 22, 2004, and DE 102004026639.5, filed Jun. 1, 2004, the entire disclosures of both of which are hereby incorporated by reference herein.

The present invention is directed to a method for determining altitude or road grade information in a motor vehicle, altitude or road grade information of a digital map being evaluated on the basis of the identified vehicle position.

### BACKGROUND

To measure the altitude and grade profile of a road, it is known to the applicant to use a barometric, or pressure, cell in conjunction with a GPS receiver. In this context, the barometric cell has the property of being able to resolve relative variations in altitude very precisely as a function of changes in the static air pressure. However, it is only able to measure absolute altitudes when the air pressure at a reference altitude is known. This is mostly not the case. For that reason, the altitude measurement of the barometric cell is combined with a GPS altitude measurement. In this context, the GPS supplies absolute altitude or road grade information, however with limited relative accuracy. If one merges altitude data from both sensors in a Kalman filter, for example, the actual altitude profile of a road is able to be determined very precisely. By differentiating the altitude data, it is possible to calculate the road grade profile.

Alternatively to the barometric cell, a DGPS system that is highly precise in the vertical direction, or an inertial platform for recording the acceleration and rotational motion of the vehicle in three-dimensional space, can be used, and, by integration, the position and velocity of the vehicle can be calculated.

Finally, the possibility exists to infer the road grade from vehicle data, such as torque, speed and longitudinal acceleration. Such approaches are prevalent in automatic transmissions, for example, where the attempt is made in this manner to estimate the road grade at the current vehicle position and to consider the same during gear selection.

Of all the mentioned sensors and data for measuring road grades, at the customary vehicle equipment levels, merely the GPS receiver and the vehicle data on the CAN bus are present. Integrating the other sensors in the vehicle solely for purposes of road grade measurement entails costs which do not seem to be practical for the described application.

It may be that, by merging the GPS altitude with the road grade estimation derived from the vehicle data, the grade profile of the road can also be ascertained and stored in an intelligent map, however, this method has the distinct disadvantage that when a route is traveled for the first time, the digital map does not include any road grade information, so that predictive gearshift operations are not possible.

It is also known (German Application 100 30 932 A1) to measure altitude data of a vehicle in order to append these data to a digitized map. The information can then be made available, from the map, to other road users.

### SUMMARY OF THE INVENTION

An object of the present invention is, therefore, to provide a method for determining altitude or road grade information that is able to be implemented by using simple means and without entailing substantial outlay for sensory technology and that will still enable useful measurement data to be available right from the beginning.

According to the present invention, cartographic altitude or road grade information is evaluated by analyzing a GPS signal in terms of the current vehicle altitude and/or by analyzing vehicle data-based estimated altitude or road grade information. If indicated, the cartographic altitude or road grade information is corrected, and the corrected altitude or road grade information is used as the current altitude or road grade information.

Thus, in particular, the data, which have been corrected accordingly, are used immediately for the relevant application in the vehicle and are not merely used for improving the cartographic information for a future application by weighting the information accordingly.

Thus, it turns out to be advantageous as compared to the related art that, without entailing additional expenditure for sensory technology, an initial value and a comparison value are available, on whose basis, even a current measured value that is faulty to a certain degree may be utilized in a useful manner by performing a suitable weighting operation. This may include further plausibility checks that relate to current road grade values that are ascertained in advance. If the current road grade value represented an outlier as compared to these values, then an interpretation error may be inferred, for example, in the evaluation of the vehicle data.

### BRIEF DESCRIPTION OF THE DRAWING

The present invention is elaborated upon below based on an exemplary embodiment with reference to the drawing.

FIG. 1 shows a flow chart depicting a method for determining altitude or road grade information in a motor vehicle.

### DETAILED DESCRIPTION

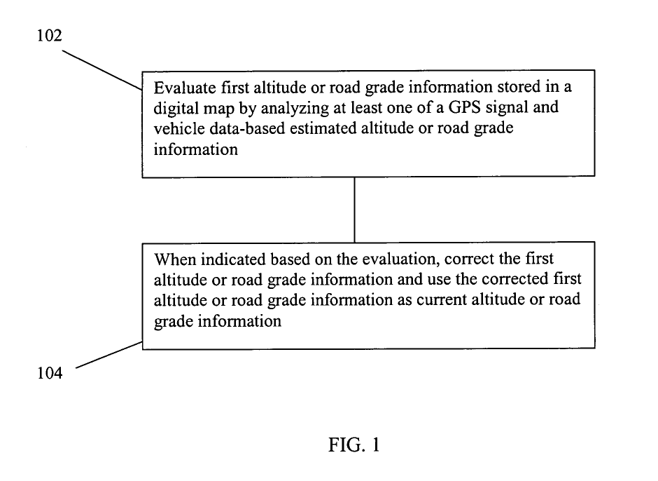

FIG. 1 shows a flow chart depicting a method for determining altitude or road grade information in a motor vehicle. First altitude or road grade information stored in a digital map is evaluated by analyzing at least one of a GPS signal and vehicle data-based estimated altitude or road grade information (see block 102). When indicated based on the evaluation, the first altitude or road grade information is corrected and the corrected first altitude or road grade information is used as current altitude or road grade information (see block 104).

The digital map may be initialized using road grade data, for example, which had been obtained from digital terrain models (DTM). Such a procedure is described in unpublished German patent application DE 10 2004 014 322.6, filed Mar. 22, 2004, which is assigned to the assignee of the present application, and the entire disclosure of which is hereby incorporated by reference herein. These DTM road grades are then used, in addition to the GPS altitude and the road grade estimation from vehicle data, as additional measured quantities for calculating and storing improved road grade information during vehicle operation. A suitable method for calculating the improved road grade information is the use of a Kalman filter, for example, which merges the various measured quantities in consideration of the particular measuring error characteristic.

In this context, it turns out to be especially beneficial that the DTM data are available virtually on a worldwide basis and free of charge. Thus, road grade information may be generated very cost-effectively and on an area-wide basis from these data and stored in a digital map.

Thus, using these cartographic road grades, an additional road grade sensor is able to be obtained, which, thanks to the digital map, is able to be integrated in the vehicle much more cost effectively than, for example, a barometric cell or an inertial platform, which would have to be installed as self-contained sensors.

It turns out that the cartographic road grades may, in fact, not be error-free, but are precise enough to suffice already by themselves for a predictive gearshift control. In any case, the road grades stored in the map make it possible for road grades to be predicted already when a route is traveled for the first time.

Advantageously, suitable corrections may also be stored in the digital map for future applications. The data material of the digital map is thereby improved.

It is also advantageous in this context for a storing operation to also be performed when no correction is made. This means then that the route in question has been checked and that the cartographic data have been verified based on the measured data. Therefore, the reliability of the cartographic data for these route sections is improved.

1. A method for determining altitude or road grade information in a motor vehicle, the method comprising:
evaluating first altitude or road grade information stored in a digital map by analyzing at least one of a GPS signal and vehicle data-based estimated altitude or road grade information; and
when indicated based on the evaluating, correcting the first altitude or road grade information and using the corrected first altitude or road grade information as current altitude or road grade information.

2. The method as recited in claim 1 further comprising storing the corrected first altitude or road grade information in the digital map.

3. The method as recited in claim 1 further comprising generating the first altitude or road grade information using at least one digital terrain model.

4. The method as recited in claim 2 further comprising generating the first altitude or road grade information using at least one digital terrain model.

5. The method as recited in claim 1 wherein the analyzing the GPS signal is performed with respect to a current vehicle altitude.
